(19) United States
(12) Patent Application Publication
(10) Pub. No.: US 2007/0182522 A1
(43) Pub. Date: Aug. 9, 2007

(54) Varistor having ceramic case

(76) Inventor: Bi-Yung Chang, Yuanlin Town (TW)

Correspondence Address: BACON & THOMAS, PLLC, 625 SLATERS LANE, FOURTH FLOOR, ALEXANDRIA, VA, 22314, US

(21) Appl. No.: 11/429,106

(22) Filed: May 8, 2006

(30) Foreign Application Priority Data
Feb. 9, 2006 (TW) 95104308

(51) Int. Cl. H01C 7/10

(52) U.S. Cl. 338/21

(57) ABSTRACT

The present invention discloses a varistor which comprises a ceramic case made from insulated refractory and at least one zinc-oxide ceramic housed in the ceramic case. The ceramic case is also filled with an insulated resin having the damp-proof effect and thus serves as a powerful clamp with enough mechanical strength against impact at high temperature. Accordingly, the varistor can be secured from flaming and explosion when the zinc-oxide ceramic is overloaded or ineffective.

### BACKGROUND OF THE INVENTION

1. Field of the Invention

The present invention relates to a varistor, and more particularly to a varistor having a ceramic case for protecting the varistor from explosion and flaming.

2. Related Prior Arts

FIG. 1 shows a traditional varistor which is composed of a ceramic absorber 90, two electrodes disposed on the opposite sides of the absorber 90, and two leads 91, 92. In FIG. 1(a), only the electrode 91 is illustrated, and the leads 91, 92, usually made from tinned copper wires, are welded on the respective electrodes. In FIG. 1(b), the absorber is embedded with a packaging resin 93 for damp-proof and insulation effects. The packaging resin 93 is usually epoxy resin. For operation, the ceramic absorber 90 may protect the power circuit with grain boundary thereof. However, the ceramic absorber 90 very possibly reaches a high temperature when overloaded or ineffective, and therefore the outside packaging resin 93 would burn as flammability thereof.

To avoid such dangerous situation, the present invention provides a ceramic case to the traditional varistor. By selecting proper material, the ceramic may have enough mechanical strength and nonflammability so as to protect the power circuit from explosion and flaming.

### SUMMARY OF THE INVENTION

The object of the present invention is to provide a varistor having a ceramic case, so that the varistor can be safer from explosion and burning.

The varistor primarily comprises at least one ceramic absorber, at least two leads, a packaging resin and a ceramic case. The ceramic absorber has a positive electrode and a negative electrode respectively connected to two leads which conducts the surge current to the ceramic absorber from converting electricity into heat. The packaging resin has good damp-proof and insulation properties and can embed the ceramic absorber completely. The ceramic case is preferably made from an insulated ceramic material sintered at high temperature, so as to exhibit superior mechanical strength and nonflammability. The ceramic absorber and the packaging resin are housed in the ceramic case which has at least one opening for the leads extending outside. As a result, the varistor can be secured with the ceramic case even though the ceramic absorber is ineffective.

Types or positions of the opening of the ceramic case is not restricted, and preferably disposed corresponding to the leads. The ceramic case can be composed of a container and a cover. The opening can be formed on the cover, or beneath the container opposite to the cover. The ceramic case is preferably durable for at least 5 minutes at 700° C., 1 atmosphere. Proper material for the ceramic case includes Al₂O₃, SiO₂ or MgO, or a mixture thereof; and preferably contains 25˜99 wt % of Al₂O₃. The ceramic case can further house a thermistor.

The ceramic absorber can be typically disk-shaped, or has a three-layered structure. The packaging resin is normally uses phenolic resin, silicone resin, epoxy resin, or a mixture thereof.

### BRIEF DESCRIPTION OF THE DRAWINGS

FIG. 1 shows a traditional varistor and packaged with epoxy resin;

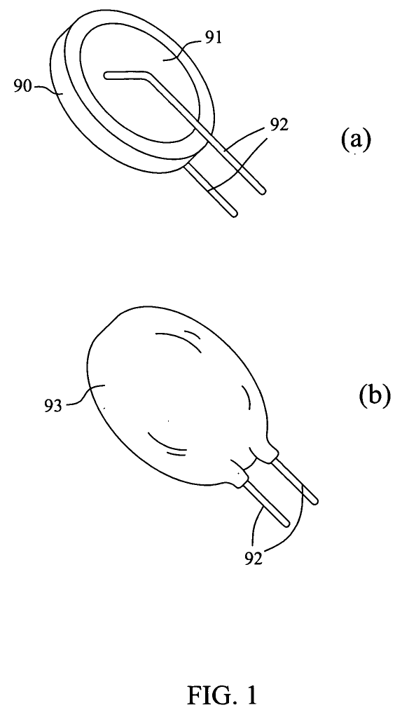

FIG. 2 shows the varistor of the present invention and a cross view thereof; and

FIG. 3 shows different types of the cover and the container of the ceramic case.

### DETAILED DESCRIPTION OF THE PREFERRED EMBODIMENTS

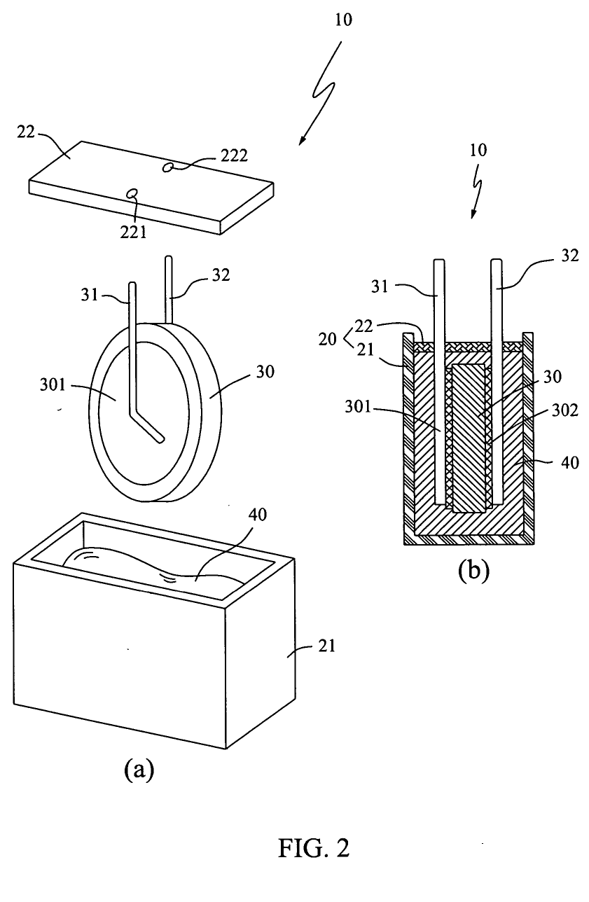

FIG. 2 shows a varistor of the present invention and a cross view thereof. The varistor 10 comprises a ceramic case 20, a ceramic absorber 30 with electrodes 301, 302, leads 31, 32, and a packaging resin 40. One end of each of the leads 31, 32 is welded to the respective electrodes 301, 302 of the ceramic absorber 30, so that surge current can be conducted to the ceramic absorber 30 via the leads 31, 32 and converted into heat. The packaging resin 40 performs both of damp-proof and insulation properties, and can embed the ceramic absorber 30 completely. A major feature of the present invention is the ceramic case 20, which is made from an insulated ceramic material previously sintered at high temperature, and thus performs superior mechanical strength and nonflammability. The ceramic absorber 30 and the packaging resin 40 are housed in the ceramic case 20. The ceramic case 20 is composed of a container 2l and a cover 22, wherein the cover 22 has two openings 221, 222 disposed corresponding to the leads 31, 32.

A preferred method for producing the varistor is described as follows:
1. cleaning the ceramic absorber 30 welded with the leads 31, 32 to eliminate residual solder and impurities;
2. adding the packaging resin 40 into the container 21 at a volume of about 5%˜100% of the ceramic case 20;
3. placing the ceramic absorber 30 with the leads into the container 21, then filling the container 21 with the packaging resin 40 to completely cover the ceramic absorber 30, and engaging the cover 22 into the container 21 with the leads 31, 32 extending from the opening 221, 222;
4. drying and solidifying the packaging resin 40 by baking to achieve the varistor as the above embodiment.

In another producing embodiment, the ceramic absorber 30 is previously dipped in the packaging resin 40 by clamping the leads 31, 32, and then placed into the container 21.

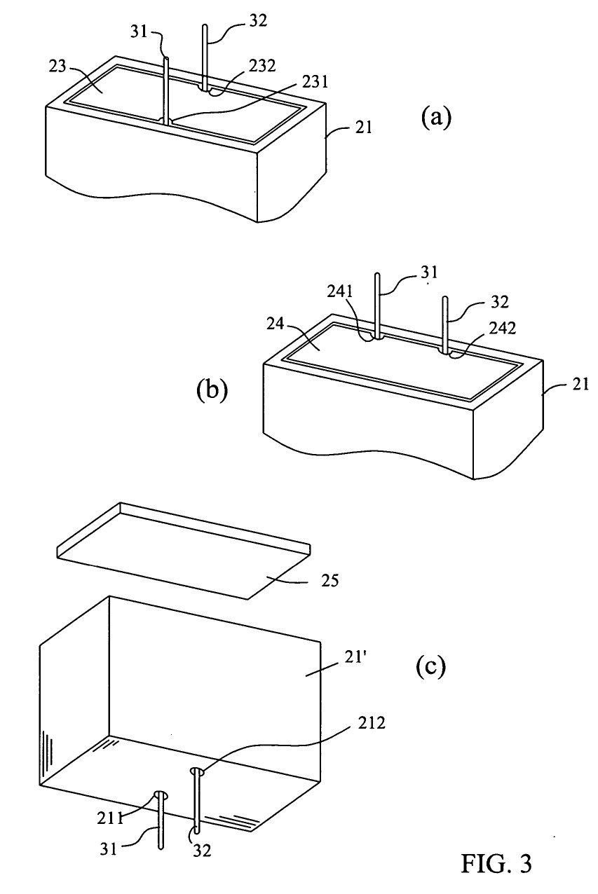

Additionally, types and positions of the opening(s) can be arranged optionally for the leads 31, 32 extending from the ceramic case 20. FIG. 3 illustrates different assemblies of the container and the cover. In FIG. 3(a), two nicks 231, 232 are respectively formed on opposite edges of the cover 23, and the leads 31, 32 can protrude from the nicks 231, 232. In FIG. 3(b), two nicks 241, 242 are formed on the same edge of the cover 24, and the leads 31, 32 can protrude. In FIG. 3(c), the cover 25 has smooth edges, and two openings 211, 212 are formed beneath the container 21′. With respective to the other embodiments, the ceramic absorber 30 is placed up side down for the leads 31, 32 respectively protruding from the opening 211, 212, and then the container 21′ is filled with the packaging resin 40. At last, the cover 25 is engaged into the container 21′.

In the present invention, the packaging resin is preferably phenolic resin, and other known resins are suitable, for example, silicone resin or epoxy resin. The packaging resin is preferably insulated polymers with high electrical resistance and density, and can protect the ceramic absorber from damp or contaminants. Further, the packaging resin is viscous and mobile, which facilitates to secure the ceramic absorber and the cover in the container and stuff the space between the openings and the leads.

Though stress from the ceramic absorber will be mostly applied to the two sides with larger surface areas than to the cover, it's still safer to well design the details. For example, slight space or packaging resin can be provided between the openings (or nicks) and the leads, or between the cover and the container and thus serves as a buffer for heat expansion. Further, the cover is disposed in the container away from the top edges a desired distance, so that the cover can shift upward when heat expansion occurs.

According to the present invention, the ceramic case can function as a protector of the varistor from explosion or flaming when the ceramic absorber is ineffective due to overloading or aging/worsening of material. That is, the ceramic case is required to be made from a material with good mechanical strength and nonflammability; for example, Al₂O₃, SiO₂ or MgO. Particularly, the material containing 25˜99 wt % of Al₂O₃ is preferred due to advantages as follows:
1. Good mechanical strength at high temperature

When surge current is instantly conducted via the leads within micro-seconds, very high temperature is reached on a local area of the ceramic absorber. If the temperature is over 700° C., the ceramic absorber is possibly ineffective and begins burning. However, the ceramic case made from Al₂O₃ can still remain good mechanical strength even at 1,000° C., and therefore the ceramic absorber can be powerfully clamped within the ceramic case without breakdown, burning and explosion.
2. High heat-transfer rate

The traditional varistor is simply packaged with silicone or epoxy resin through which the heat is slowly diffused according to the temperature gradient between the resin and the leads or the air. In the present invention, the ceramic case made from Al₂O₃ with high coefficient of heat transfer can effectively conduct heat away by contacting the packaging resin. As a result, accumulation of heat is avoided and the varistor can be used for a longer time.
3. Flat contact surface to the TCO fuse

In general, a positive temperature coefficient (PTC) thermistor or a thermal cut-off (TCO) fuse will be housed in the ceramic case. The PTC thermistor or TCO fuse can increase resistance to reduce the current or fuse instantly, when the temperature of the varistor is raised due to surge current. The traditional varistor is normally packaged as an inflated tablet with bulgy surfaces. When the TCO fuse is attached to such surface, the contact area is very limited to a point or a line. Therefore, the TCO fuse could not sensitively respond to the real temperature of the varistor and thus fails to protect the power circuit. In the present invention, the flat surfaces of the Al₂O₃ ceramic case may provide large contact areas to the TCO fuse, and thus improve protection of the TCO fuse. However, it should be noticed that other materials with suitable characteristics can also be applied to the ceramic case in addition to Al₂O₃.

While the present invention has been illustrated with the above preferred embodiments, it should be noticed that any modifications or variations in materials, arrangements and shapes deducing from these embodiments still belong to the scope of the present invention.

What is claimed is:

1. A varistor, comprising:
at least one ceramic absorber having a positive electrode and a negative electrode;
at least two leads respectively connected to the positive electrode and the negative electrode of the ceramic absorber and conducting surge current to the ceramic absorber for converting the surge into heat;
a packaging resin having damp-proof and insulation properties and completely embedding the ceramic absorber therein; and
a ceramic case made from insulated ceramic material sintered at high temperature, having a desired mechanical strength and nonflammability, housing the ceramic absorber and the packaging resin therein, and having at least one opening for the leads extending outside;
according to protection of the ceramic case, the varistor will not bum and explode as the ceramic absorber is ineffective.

2. The varistor as claimed in claim 1, wherein the ceramic case has two openings disposed corresponding to two leads.

3. The varistor as claimed in claim 1, wherein the ceramic case is composed of a container and a cover.

4. The varistor as claimed in claim 3, wherein the opening of the ceramic case is formed on the cover.

5. The varistor as claimed in claim 3, wherein the opening of the ceramic case is formed beneath the container opposite to the cover.

6. The varistor as claimed in claim 1, wherein the ceramic case is durable for at least 5 minutes at 700° C., 1 atm.

7. The varistor as claimed in claim 1, wherein the ceramic case is made from Al₂O₃, SiO₂ or MgO, or a mixture thereof.

8. The varistor as claimed in claim 1, wherein the ceramic case is made from a material containing 25˜99 wt % of Al₂O₃.

9. The varistor as claimed in claim 1, wherein the ceramic absorber has a three-layered structure.

10. The varistor as claimed in claim 1, wherein the packaging resin is selected from the group consisting of phenolic resin, silicone resin and epoxy resin, or a mixture thereof.

11. The varistor as claimed in claim 1, wherein the ceramic case further houses a thermistor.
